(19) United States
(12) Patent Application Publication
(10) Pub. No.: US 2026/0212575 A1
(43) Pub. Date: Jul. 23, 2026

(54) INFORMATION PROCESSING APPARATUS AND COMPUTER PROGRAM

(71) Applicant: Bandai Co., Ltd., Tokyo (JP)

(72) Inventors: Ryota KIYOMIYA, Tokyo (JP); Taro INAYOSHI, Tokyo (JP)

(21) Appl. No.: 19/442,643

(22) Filed: Jan. 7, 2026

(30) Foreign Application Priority Data
Jan. 22, 2025 (JP) 2025-009393

(51) Int. Cl. G06T 13/20; G06T 17/00; G06V 20/64

(52) U.S. Cl. CPC G06T 13/20; G06T 17/00; G06V 20/653

(57) ABSTRACT

An information processing apparatus includes: a scanning control unit that controls a position and an angle of a scanner, scans an installed subject, and generates a scanned image; a data generation unit that generates three-dimensional model data from the scanned image; a determination unit that determines a type of the subject on the basis of a rendered image of the subject generated on the basis of the three-dimensional model data; a data generation unit that generates output data including video in which a three-dimensional model based on the three-dimensional model data is arranged in a virtual space; and an output unit that outputs the output data to an external output apparatus, in which the data generation unit generates the output data so as to include production for each subject according to the type of the subject determined by the determination unit.

### CROSS REFERENCE TO RELATED APPLICATIONS

This application claims priority to Japanese Application No. 2025-009393, filed Jan. 22, 2025, the content of which is hereby incorporated by reference in its entirety.

### BACKGROUND

### 1. Technical Field

The present disclosure relates to an information processing apparatus and a computer program.

### 2. Description of the Related Art

JP 2006-247178 A describes a technique of mapping a texture generated from a group of captured images obtained by imaging an object from a plurality of imaging directions by an imaging unit onto a primitive in a virtual space and generating a virtual space image seen from a virtual camera in the virtual space.

### BRIEF SUMMARY

In generation of a virtual space image as in the above technique, when an object is imaged and video in which a three-dimensional model is arranged in a virtual space is output by using three-dimensional model data of the imaged object, it is expected that different types of production can be given according to the type of the object.

In view of this, an object of an aspect of the present disclosure is to, when an object is imaged and video in which a three-dimensional model is arranged in a virtual space is generated by using three-dimensional model data of the imaged object, perform different types of production according to the type of the object.

One aspect to solve the above problem is an information processing apparatus including: a scanning control unit that controls a position and an angle of a scanner, scans an appearance of a subject installed on an installation base, and generates a scanned image; a data generation unit that generates three-dimensional model data from the scanned image; a determination unit that determines a type of the subject from among a plurality of types on the basis of a rendered image of the subject generated on the basis of the three-dimensional model data; a data generation unit that generates output data including video in which a three-dimensional model based on the three-dimensional model data is arranged in a virtual space; and an output unit that outputs the output data to an external output apparatus, in which the data generation unit generates the output data so as to include production for each subject according to the type of the subject determined by the determination unit.

When an object is imaged and video in which a three-dimensional model is arranged in a virtual space is generated by using three-dimensional model data of the imaged object, it is possible to perform different types of production according to the type of the object.

### BRIEF DESCRIPTION OF THE DRAWINGS

FIG. 1 is a diagram illustrating a configuration example of an image processing system according to an embodiment;

FIGS. 2A to 2C are diagrams illustrating an example of a hardware configuration of an information processing apparatus, an example of a hardware configuration of a headset, and an example of a hardware configuration of an operation apparatus according to the embodiment;

FIG. 3A is a diagram illustrating an example of an appearance of a doll model according to the embodiment;

FIG. 3B is a diagram illustrating another example of the appearance of the doll model according to the embodiment;

FIG. 3C is a diagram illustrating still another example of the appearance of the doll model according to the embodiment;

FIG. 4A is a diagram illustrating an example of implementation of the image processing system;

FIG. 4B is a diagram illustrating a configuration example of the image processing system according to the embodiment at the time of scan imaging;

FIG. 4C is a diagram illustrating an example of an external configuration of the operation apparatus according to the embodiment;

FIG. 5 is a flowchart corresponding to an example of processing in the image processing system according to the embodiment;

FIG. 6 is a diagram illustrating an example of a display screen of a type determination result according to the embodiment;

FIG. 7A is a diagram illustrating an example of a data table configuration related to production for each type according to the embodiment; and

FIG. 7B is a diagram illustrating an example of a configuration of a data table that manages data of reference images according to the embodiment.

### DETAILED DESCRIPTION OF VARIOUS EMBODIMENTS

Hereinafter, an embodiment will be described in detail with reference to the accompanying drawings. Note that the following embodiment does not limit the disclosure according to the claims, and all combinations of features described in the embodiment are not necessarily essential to the disclosure. Two or more features of a plurality of features described in the embodiment may be arbitrarily combined. Further, the same or similar components are denoted by the same reference signs, and redundant description will be omitted. In each drawing, upper, lower, left, right, front, and back directions with respect to the paper surface are used as upper, lower, left, right, front, and back directions of components (or parts) in the present embodiment in the description of the present disclosure.

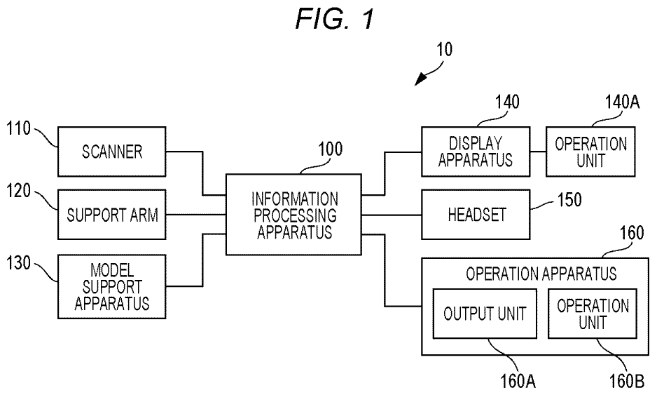

First, a configuration of an image processing system according to the present embodiment will be described. FIG. 1 is a diagram illustrating an example of a configuration of an image processing system 10 according to the present embodiment. The image processing system 10 is configured by connecting a scanner 110, a support arm 120, a model support apparatus 130, a display apparatus 140, a headset 150, an operation apparatus 160, and the like to an information processing apparatus 100. Note that the system configuration is not limited to that illustrated in FIG. 1, and the information processing apparatus 100 may be further connected to an external server, a cloud server, or the like via a network. The external server or the like can execute at least a part of processing of the embodiment described below.

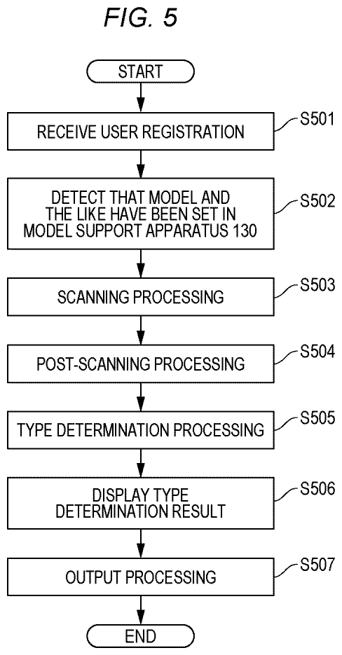

The information processing apparatus 100 controls an operation of at least one of the scanner 110, the support arm 120, and the model support apparatus 130, generates a plurality of images by imaging an article to be imaged from an arbitrary angle, and generates three-dimensional model data (present data) from the plurality of images. In a case where the article to be imaged is separable into a plurality of constituent articles, each of the constituent articles may be imaged to generate three-dimensional model data, and those pieces of the three-dimensional model data may be integrated to generate three-dimensional model data of the target article. Further, the information processing apparatus 100 can perform processing (type determination processing) of analyzing a rendered image obtained from the three-dimensional model data and determining the type of a subject to be scanned. Details of the type determination processing will be described in detail with reference to a flowchart of FIG. 5 and the like.

The information processing apparatus 100 can also function as a video generation apparatus that generates video to be displayed in a virtual space by using the generated three-dimensional model data as virtual space data. In the present embodiment, the subject to be imaged is an article such as an assemblable plastic model, an action figure (a figure including movable joint portions), a toy body, or a doll, and these are collectively referred to as a “model” below. The generated video is provided for the headset 150 and the operation apparatus 160 to be displayed for a user.

Next, the scanner 110 is a three-dimensional scanner apparatus that images (scans) a three-dimensional shape of a model to be imaged under the control of the information processing apparatus 100 and outputs the three-dimensional shape and color information of the target to be imaged. In the present embodiment, scan signals output from the scanner 110 are collectively referred to as a “scanned image”. For example, Space Spider manufactured by Artec Co., Ltd. can be used as the scanner 110. In the present embodiment, for example, 3D scanned data of the entire toy body can be acquired by acquiring about 500 to 800 frames of scanned images. Further, for example, a smartphone with a camera in which an application for imaging a three-dimensional shape is installed may be used as the scanner 110.

The support arm 120 is a position posture control apparatus that moves the scanner 110 to a predetermined imaging position and posture under the control of the information processing apparatus 100. The support arm 120 may be able to manually change the imaging position and posture and fixedly maintain the changed position and posture or may be controllable by the information processing apparatus 100. In a case where the support arm 120 is controllable by the information processing apparatus 100, for example, xArm 7 manufactured by UFACTORY can be used. The product xArm7 is composed of seven joints and can move in a similar manner to a human arm. Note that the scanner 110 may be manually positioned instead of the support arm 120. Further, the scanner 110 may be manually operated for an imaging position and posture that cannot be changed by the support arm 120, thereby performing scanning.

The model support apparatus 130 is a support base that supports a model in a fixed pose (or an installation base on which a model is installed). The model support apparatus 130 may be rotatable, for example, in a state where the model is installed on the support base or installed at the tip of a support rod. In the present embodiment, after the scanner 110 is positioned at an arbitrary imaging position and imaging angle by the support arm 120, the model support apparatus 130 is rotated, and imaging is performed. The model support apparatus 130 is rotatable in both clockwise and counterclockwise directions. The model support apparatus 130 can be stopped at an arbitrary rotation angle within a range of 0 degrees to 360 degrees, and imaging can also be performed by stopping the model support apparatus 130 at a specific rotation angle and positioning the scanner 110 at an arbitrary imaging position and imaging angle within a movable range thereof. By performing the above at a plurality of rotation angles, imaging positions, and imaging angles, an image of the entire model can be acquired. Note that, here, imaging processing can be performed more easily and with high accuracy by driving the support arm 120 and the model support apparatus 130 in synchronization. Instead of the model support apparatus 130, the scanner 110 may be manually moved around the model to scan the model from an arbitrary imaging position and imaging angle.

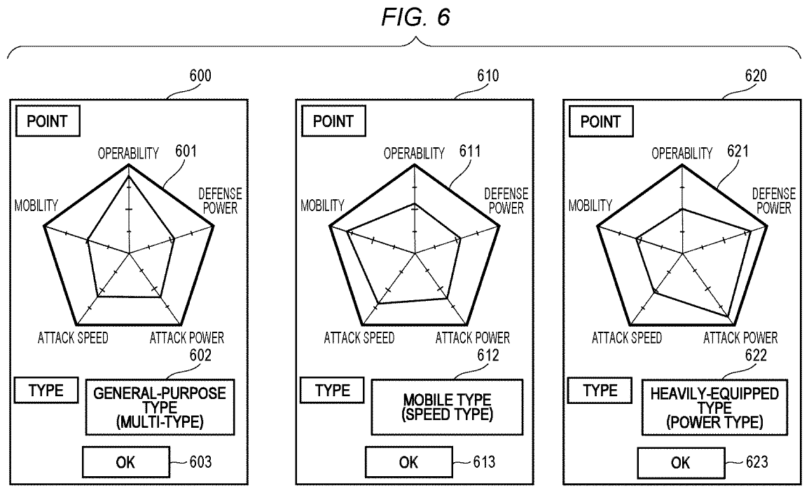

The display apparatus 140 is a display apparatus such as a liquid crystal display (LCD) and can display a processing result in the information processing apparatus 100. Specifically, it is possible to display an image acquired by the scanner 110, display present data of three-dimensional model data generated from the captured image, and display video (VR video) reconstructed by using the present data. A degree of progress during scanner processing can also be displayed on the meter. Further, it is possible to display information regarding the type of a subject to be scanned and a specific parameter value according to the present embodiment. An example of a display screen displayed here will be described later with reference to FIG. 6. The display apparatus 140 can include an operation unit 140A that receives an operation from the user who is an observer of displayed video, and the user can operate the operation unit 140A to perform an operation input according to the content of the video displayed on the display apparatus 140.

The headset 150 includes a head mounted display 150A and a controller 150B described later. In particular, the headset may be configured as a VR headset that can provide a moving image according to a posture or inclination of the user who is an observer. A predetermined application is installed in the headset 150, and application data executed in the application can be executed by being downloaded from the information processing apparatus 100. In the present embodiment, the headset 150, as well as the information processing apparatus 100, can function as a video generation apparatus that generates video to be displayed in a virtual space by using three-dimensional model data as virtual space data and provides the generated video as VR video. Note that the application data includes output data for outputting the VR video and the like.

The operation apparatus 160 includes an output unit 160A and an operation unit 160B and can provide video to be displayed in a virtual space by using the three-dimensional model data as the virtual space data, which is provided from the information processing apparatus 100, for the user via the output unit 160A and can receive an operation on the displayed video from the user via the operation unit 160B. The received operation result is transmitted to the information processing apparatus 100, and the displayed video is updated.

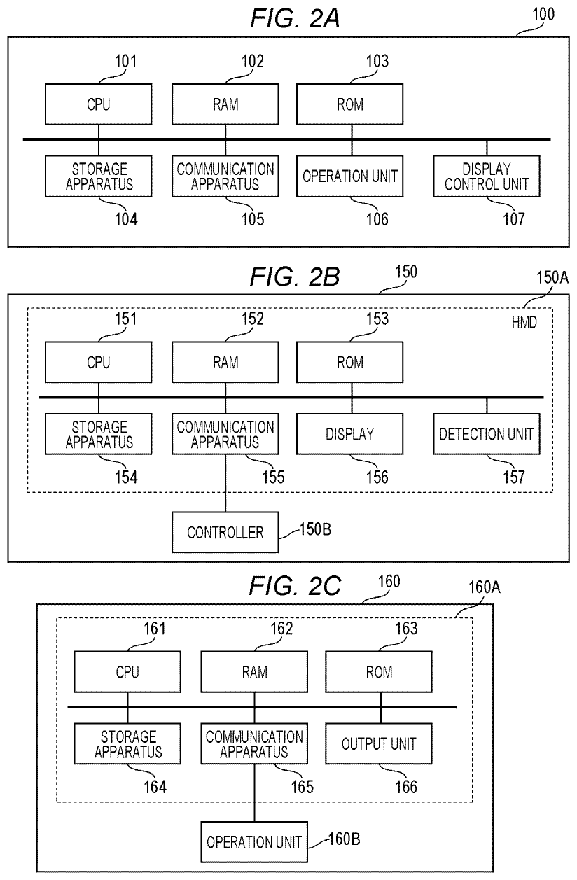

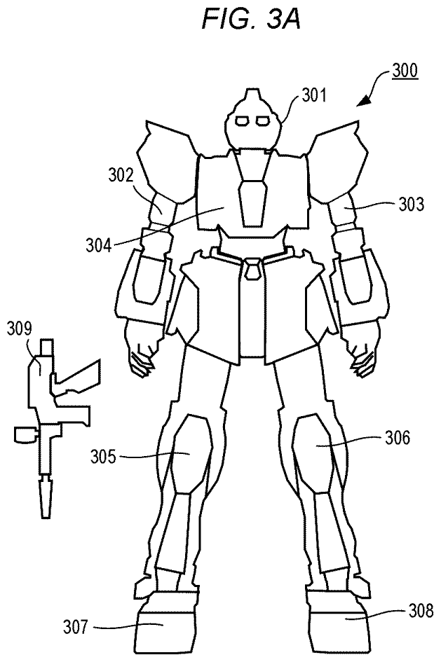

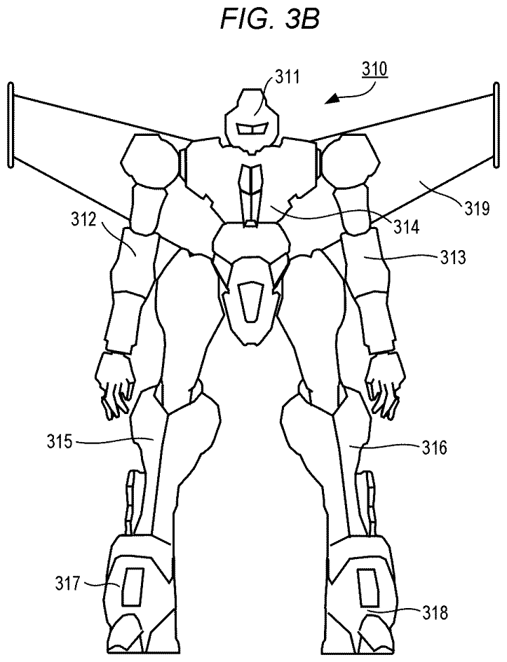

Next, a hardware configuration of the information processing apparatus 100 according to the present embodiment will be described. FIG. 2A illustrates an example of a hardware configuration of the information processing apparatus 100. A CPU 101 is an apparatus that performs overall control of the information processing apparatus 100 and calculation, processing, and management of data. For example, it is possible to arrange the scanner 110 at an arbitrary imaging position and imaging angle by controlling a timing of capturing an image and the number of capturing images in the scanner 110 and controlling joints of the arm of the support arm 120. For example, after the imaging position and the imaging angle of the scanner 110 are determined, it is possible to rotate the model support apparatus 130 and perform an imaging operation by the scanner 110. After the model support apparatus 130 is stopped at a predetermined rotation angle, it is possible to perform an imaging operation by the scanner 110 at an arbitrary imaging position and imaging angle.

The CPU 101 can also function as an image processing unit that processes an image output from the scanner 110. Specifically, the CPU 101 can perform processing of generating video for displaying a three-dimensional model in a virtual space by using three-dimensional model data generated on the basis of a scan signal obtained by the scanner 110 as virtual space data. The CPU 101 also performs processing of generating a rendered image from the three-dimensional model data acquired from the scanner 110, determining a predetermined parameter value for an appearance of a subject to be scanned, and determining the type of the subject on the basis of the determined parameter value. Based on the processing result, the CPU 101 generates output data to be output to the display apparatus 140 or the output unit 160A of the operation apparatus 160. The output data to be output to the operation apparatus 160 includes production data for performing various types of production, such as video data, audio data, vibration data, air blowing data, and light emission data.

A RAM 102 is a volatile memory and is used as a temporary storage area such as a main memory and a work area of the CPU 101. A ROM 103 is a nonvolatile memory and stores image data, other types of data, various programs for operating the CPU 101, and the like in predetermined areas. The CPU 101 controls each unit of the information processing apparatus 100 by using the RAM 102 as a work memory according to the programs stored in the ROM 103, for example. Note that programs for operating the CPU 101 are not limited to the programs stored in the ROM 103 and may be stored in a storage apparatus 104.

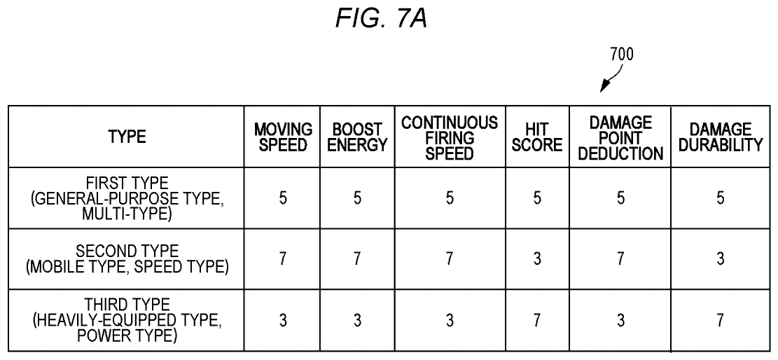

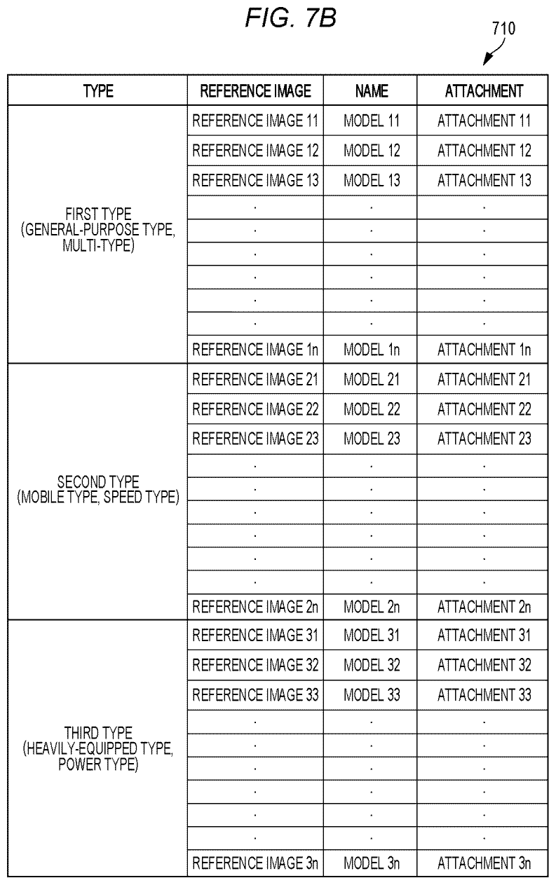

The storage apparatus 104 includes, for example, a magnetic disk such as an HDD or a flash memory. The storage apparatus 104 stores an application program, an OS, a control program, a related program, a game program, and the like. The storage apparatus 104 can read and write data under the control of the CPU 101. The storage apparatus 104 may be used instead of the RAM 102 or the ROM 103. The storage apparatus 104 also stores information of tables illustrated in FIGS. 7A and 7B described later.

A communication apparatus 105 is a communication interface for communicating with the scanner 110, the support arm 120, the model support apparatus 130, the display apparatus 140, the headset 150, and the operation apparatus 160 under the control of the CPU 101. The communication apparatus 105 may further be able to communicate with an external server or the like. The communication apparatus 105 can include a wireless communication module, and the module can include well-known circuitry including an antenna system, an RF transceiver, one or more amplifiers, a tuner, one or more oscillators, a digital signal processor, a CODEC chipset, a subscriber identity module card, a memory, and the like. Here, the information processing apparatus 100 may communicate with the scanner 110, the support arm 120, the model support apparatus 130, the display apparatus 140, the headset 150, and the operation apparatus 160 by wireless communication.

The communication apparatus 105 may also include a wired communication module for wired connection. The wired communication module can communicate with other devices including the display apparatus 140 and the operation apparatus 160 via one or more external ports. Further, various software components that process data may be included. The external port is directly coupled to another device via Ethernet, USB, IEEE1394, or the like or indirectly coupled to another device via a network. Note that software that achieves functions equivalent to those of the above apparatuses can be configured as an alternative to a hardware apparatus.

The operation unit 106 includes, for example, a button, a keyboard, a touchscreen, and a controller and receives an operation input from the user. The operation unit 106 may be shared with the operation unit 140A and the operation unit 160B of the operation apparatus 160 or may be independent of the operation unit 140A and the operation unit 160B. For example, in a case where the operation unit 140A is assumed to be an operation unit configured as a keyboard, a mouse, or the like, the operation unit can be shared with the operation unit 106. Meanwhile, in a case where the operation unit 140A is assumed to be an operation unit configured as a touchscreen, a controller, or the like, the operation unit can be an operation unit separate from the operation unit 106.

A display control unit 107 functions as a control unit for displaying information on the display apparatus 140 or the output unit 160A of the operation apparatus 160 connected to the information processing apparatus 100 and controls operations of the display apparatus 140 and the output unit 160A. Some functions of the operation unit 106 may be provided in the display apparatus 140 or the output unit 160A. For example, the display apparatus 140 may be configured as an apparatus including a touchscreen such as a tablet terminal.

Next, a hardware configuration of the headset 150 according to the present embodiment will be described. FIG. 2B illustrates an example of a hardware configuration of the headset 150. The headset 150 includes the head mounted display (HMD) 150A and the controller 150B. The HMD 150A provides right-eye video and left-eye video for the left and right eyes of the user, respectively, and causes the user to feel a stereoscopic effect due to parallax therebetween, thereby enabling virtual reality (VR) experience. The controller 150B is provided in a housing independent of the HMD 150A. The controller 150B is assumed to be a pair of two controllers in order to be held and operated by the left and right hands of the user, but may be a single controller.

A CPU 151 is an apparatus that performs overall control of the headset 150 and calculation, processing, and management of data. For example, it is possible to execute the application data downloaded from the information processing apparatus 100 to display VR video on a display 156. It is also possible to switch the VR video itself to be displayed, switch a viewpoint in a VR space, or change a position in the VR space on the basis of an operation received via the controller 150B or information detected by a detection unit 157.

A RAM 152 is a volatile memory and is used as a temporary storage area such as a main memory and a work area of the CPU 151. A ROM 153 is a nonvolatile memory and stores image data, other types of data, various programs for operating the CPU 151, and the like in predetermined areas. The CPU 151 controls each unit of the headset 150 by using the RAM 152 as a work memory according to the programs stored in the ROM 153, for example. Note that programs for operating the CPU 151 are not limited to the programs stored in the ROM 153 and may be stored in a storage apparatus 154.

The storage apparatus 154 includes, for example, a magnetic disk such as an HDD or a flash memory. The storage apparatus 154 stores an application program, an OS, a control program, a related program, a game program, application data downloaded from the information processing apparatus 100, output data, and the like. The storage apparatus 154 can read and write data under the control of the CPU 151. The storage apparatus 154 may be used instead of the RAM 152 or the ROM 153.

A communication apparatus 155 is a communication interface for communicating with the information processing apparatus 100 and the controller 150B under the control of the CPU 151. The communication apparatus 155 includes a wireless communication module that enables wireless communication based on Bluetooth or WiFi (IEEE802.11). The headset 150 is connected to the information processing apparatus 100 by wireless communication and can download output data including display data for VR video. Further, communication is performed with the controller 150B to receive information regarding a user's operation instruction for the controller 150B.

The display 156 provides right-eye video and left-eye video generated by the CPU 151 to the right eye and the left eye of the user, respectively. The detection unit 157 is a mechanism for detecting line-of-sight directions of the left and right eyes of the user and detecting an inclination of the head mounted display. The detection unit 157 includes, for example, a sensor for detecting the line-of-sight direction or a gaze direction of the user wearing the HMD 150A. The detection unit also includes a gyroscope, a magnetometer, an accelerometer, a global positioning system (GPS), a compass, and the like and can identify a position, posture, inclination, and the like of the HMD 150A according to detection information thereof. The detection unit 157 detects information for determining the gaze direction or an action of the user in the HMD 150A and transmits the information to the CPU 151. The CPU 151 determines the gaze direction and the action on the basis of the received detection information and adjusts the video presented on the display 156 of the HMD 150A so as to match with the determined gaze direction and action.

The controller 150B includes, for example, a plurality of buttons and arrow keys and receives an operation input such as a selection operation and a direction instruction operation from the user. The controller 150B is connected by wireless communication to the HMD 150A via the communication apparatus 155.

Next, a hardware configuration of the operation apparatus160 according to the present embodiment will be described. FIG. 2C illustrates an example of a hardware configuration of the operation apparatus 160. The operation apparatus 160 includes the output unit 160A and the operation unit 160B. The output unit 160A outputs video, audio, vibration, air blowing, and the like to the user to enable production experience. The operation unit 160B is a member that receives an operation from the user in the operation apparatus 160 and may be provided independently of the operation apparatus 160 or may be provided integrally with the operation apparatus 160.

A CPU 161 is an apparatus that performs overall control of the operation apparatus 160. For example, the CPU performs processing for outputting video information, audio information, and other types of production information acquired from the information processing apparatus 100 via an output unit 166. Further, it is possible to switch video itself to be displayed, output audio, and switch the production information on the basis of an operation received via the operation unit 160B.

A RAM 162 is a volatile memory and is used as a temporary storage area such as a main memory and a work area of the CPU 161. A ROM 163 is a nonvolatile memory and stores image data, other types of data, various programs for operating the CPU 161, and the like in predetermined areas. The CPU 161 controls each unit of the operation apparatus 160 by using the RAM 162 as a work memory according to the programs stored in the ROM 163, for example. Note that programs for operating the CPU 161 are not limited to the programs stored in the ROM 163 and may be stored in a storage apparatus 164.

The storage apparatus 164 includes, for example, a magnetic disk such as an HDD or a flash memory. The storage apparatus 164 stores an application program, an OS, a control program, a related program, a game program, application data downloaded from the information processing apparatus 100, output data, and the like. The storage apparatus 164 can read and write data under the control of the CPU 161. The storage apparatus 164 may be used instead of the RAM 162 or the ROM 163.

A communication apparatus 165 is a communication interface for communicating with the information processing apparatus 100 and the operation unit 160B under the control of the CPU 161. The communication apparatus 165 includes a wireless communication module that enables wireless communication based on Bluetooth or WiFi (IEEE802.11). The operation apparatus 160 is connected to the information processing apparatus 100 by wireless communication and can download production data such as video data and audio data. Further, the operation apparatus communicates with the operation unit 160B to receive information regarding a user's operation instruction for the operation unit 160B.

The output unit 166 includes a production output mechanism that performs various production outputs of, for example, a display that performs video display on the basis of video data provided from the CPU 161, a speaker that performs audio output on the basis of audio data, a vibration unit that performs vibration output on the basis of vibration data, an air blowing unit that performs air blowing output on the basis of air blowing data, and a light emitting unit that performs production by light emission of an LED on the basis of light emission data.

The operation unit 160B includes, for example, a plurality of buttons, a switch, arrow keys, a joystick, a lever, a pedal, a touchscreen, and a handle and receives an operation input such as a selection operation and a direction instruction operation from the user. The operation unit 160B is connected to the output unit 160A of the operation apparatus 160 by wireless or wired communication via the communication apparatus 165.

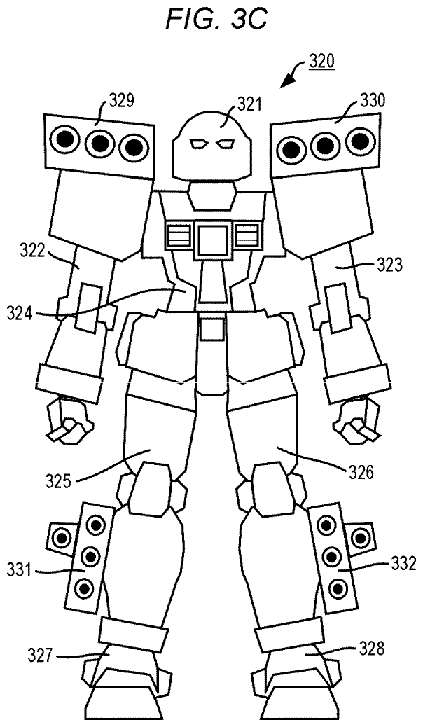

Next, an example of a model serving as a subject to be imaged and an attachment thereof in the present embodiment will be described with reference to FIGS. 3A to 3C. The model 300 is an example of a model having a doll (robot or human) appearance. The model can be assembled and painted as a plastic model, for example. Alternatively, the model may be a completed model such as a figure (action figure) including movable joint portions. The models in FIGS. 3A to 3C are merely examples for description, and the shapes of the models are not limited to a doll appearance and may be models of an arbitrary shape such as a general vehicle, a race vehicle, a military vehicle, an aircraft, a ship, an animal, and a virtual living body. It goes without saying that the article to be imaged is not limited to a model as long as the article has a three-dimensional shape that can be imaged by the scanner 110.

The model 300 includes components of a head portion 301, a right arm portion 302, a left arm portion 303, a body portion 304, a right leg portion 305, a left leg portion 306, a right foot portion 307, and a left foot portion 308 and is configured by connecting these components. At least one or more of the portions 301 to 308 are rotatably (or swingably) supported with respect to their adjacent portions. For example, the head portion 301 is rotatably supported with respect to the body portion 304, and the right arm portion 303 and the left arm portion 304 are rotatably supported with respect to the body portion 304. Because each part of the model 300 has a joint structure in this manner, the model 300 can take an arbitrary posture.

The model 300 may be accompanied by an attachment 309. The attachment 309 is an attachment part that is assumed to be used together with the model 300 and is a weapon having a rifle shape in FIG. 3A. That is, the model 300 is assumed to use the attachment 309 by gripping the attachment with both hands. The form of the weapon is not limited to the form of a rifle and may include an arbitrary form of weapon such as a sword shape, a shield shape, a bomb shape (for example, a grenade), and a bazooka shape. The attachment is not limited to the weapon as long as the attachment is an attachment part that can be used together with the model 300 and may be an accessory. For example, in a case where the model 300 is a doll model of a specific character, the attachment may include various items carried by the character (for example, a hand-carried item, a hat, a bag, an accessory, a smartphone, or other arbitrary articles that can be carried by the character).

Next, other examples of the model serving as the subject to be imaged and the attachment thereof in the present embodiment will be described with reference to FIGS. 3B and 3C. A model 310 in FIG. 3B is another example of the model having a doll (robot or human) appearance. A model 320 in FIG. 3C is still another example of the model having a doll (robot or human) appearance. Portions 311 to 318 and 321 to 328 constituting the respective models 310 and 320 correspond to the portions 301 to 308 of the model 300. Although the attachment 309 of FIG. 3A is omitted in FIGS. 3B and 3C, the attachment may be provided as in FIG. 3A. The model 310 has a clean form as a whole as compared with the model 300 and further includes a flying wing 319, thereby giving an impression of excellent mobility. The model 320 has gun mechanisms 329 to 332 and thus is heavily equipped as compared with the model 300 and the model 310, thereby giving an impression of heavy weight as a whole.

As described above, in the present embodiment, a subject to be scanned can be classified into any of three types such as a second type (mobile type, speed type) which is excellent in mobility like the model 310, a third type (heavily-equipped type, power type) which has the sense of weight like the model 320, and a first type (general-purpose type, multi-type) which is between the two types like the model 300. The sense of speed is emphasized in video production in the second type, the sense of weight is emphasized in video production in the third type, and the sense of speed and the sense of weight are between those of the second type and the third type in video production in the first type. The classification of the type of the subject will be described in more detail later. The three types are used in the present embodiment, but at least three types may be used, and more types may be prepared.

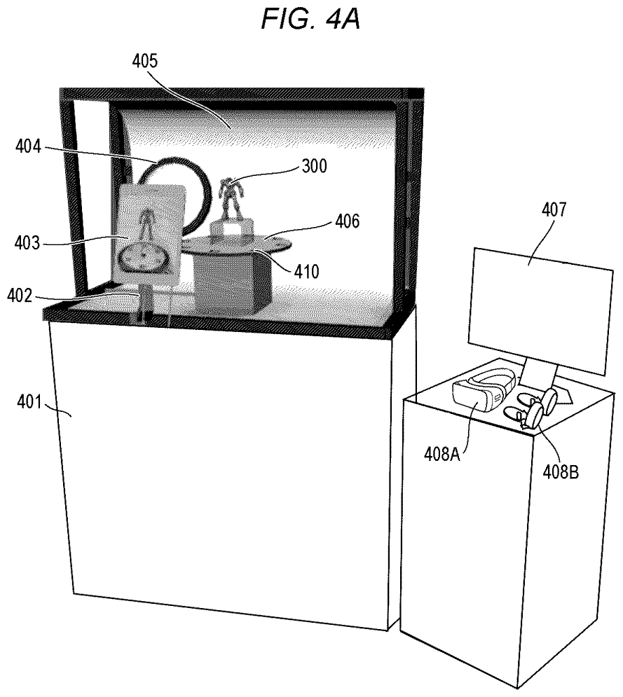

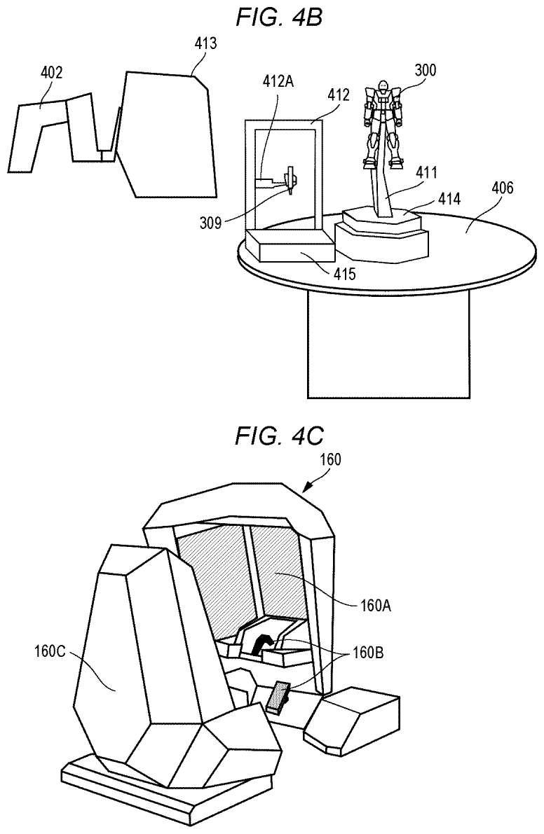

Next, an overall implementation example of the image processing system 10 in the present embodiment will be described with reference to FIGS. 4A to 4C. FIGS. 4A to 4C are diagrams illustrating a generalized implementation example where present data generated by imaging the model can be generated.

In FIG. 4A, a case 401 includes the information processing apparatus 100, a drive system for driving a support arm 402, a drive system for driving a turntable 406, and the like. The imaging direction and position of the support arm 402 can also be manually adjusted. A surface of the case 401 has a flat structure such that a poster for advertisement can be attached.

The support arm 402 corresponds to the support arm 120 and can support a terminal 403 functioning as the scanner 110 under the control of the information processing apparatus 100 or manually and fix a position thereof. The support arm 402 can also operate to control an inclination of the terminal 403.

The terminal 403 is a camera built-in touchscreen terminal that can be used as the scanner 110, and for example, a smartphone, a tablet terminal, a digital camera, or the like can be used. Instead of those terminals, Space Spider manufactured by Artec Co., Ltd. can also be used. FIG. 4A is a diagram merely illustrating a generalized example of the system configuration, and the system configuration can be a configuration according to the type of a device used as the scanner 110. The terminal 403 can capture an image of the model 300 and transmit the image to the information processing apparatus 100. A ring light 404 is an illumination apparatus used when the model 300 is imaged by the terminal 403 and can uniformly irradiate the model 300 with light to make shadows less likely to appear. In addition to the ring light 404, a top light and auxiliary lights may be installed on the left, right, and lower sides as additional light sources. Instead of the terminal 403, the three-dimensional scanner apparatus described above may be used.

A background sheet 405 is a background sheet for imaging, and for example, a white sheet can be used. The turntable 406 allows the model 300 to be mounted and can rotate the model. A configuration including the turntable 406 and the drive system thereof corresponds to the model support apparatus 130, and clockwise and counterclockwise rotation and stop operations of the turntable 406 are performed under the control of the information processing apparatus 100. A plurality of predetermined markers 410 may be arranged on the turntable 406. The marker 410 can be used to adjust a direction and position of the imaged model.

In FIG. 4A, the model is installed on a translucent (transparent) base, but, in addition to this, a support tool called “action base” (registered trademark) may be used. The action base is such that a prop configured to be bent in a V-shape is installed on a pedestal, and a model can be attached to a tip of the prop. At this time, the marker 410 may be arranged at the tip portion of the prop. A method of indicating the model can be changed according to a pose. For example, in a case of the upright posture, it is possible to perform imaging by installing the model on the transparent base. Meanwhile, in a case where the sole of the foot is also desired to be imaged like a flying posture, the action base may be used. Note that the action base may also be used to image the upright posture.

A display apparatus 407 corresponds to the display apparatus 140 and may have a touchscreen function. The user can perform a predetermined selection operation by using the touchscreen function. Instead of the touchscreen, a controller or a mouse (not illustrated) which can function as the operation unit 140A can also receive an operation. A VR headset 408 includes an HMD 408A and a controller 408B and corresponds to the HMD 150A and the controller 150B, respectively. The user can perform an operation while watching VR video by wearing the HMD 408A on the head and holding and operating the controllers 408B in the left and right hands.

Next, a more specific configuration of the image processing system 10 according to the present embodiment in a case where the model 300 and the attachment 309 are simultaneously scanned will be described with reference to FIG. 4B. In FIG. 4B, the model 300 and the attachment 309 are installed on the turntable 406. The model 300 is supported by an action base 411 and is arranged substantially at the center of the turntable 406. The attachment 309 is supported by a support member 412A in a frame 412 and is arranged adjacent to the model 300 and near an end of the turntable 406. The support member 412A can be, for example, a clip-like member. Thus, the attachment 309 can be supported in the frame 412 by being fastened with the clip.

A scanner apparatus 413 is supported by the support arm 402, and Space Spider manufactured by Artec Co., Ltd. is assumed to be used here. The drive system for driving the support arm 402, the drive system for driving the turntable 406, and the like are similar to those described in FIG. 4A, and thus the description thereof will be omitted. In the present embodiment, the turntable 406 can rotate in both clockwise and counterclockwise directions.

In the present embodiment, the model 300 and the attachment 309 are collectively installed on the turntable 406 in the form of FIG. 4B and are collectively imaged by the scanner apparatus 413 to generate a scanned image. The scanned image includes both the model 300 and the attachment 309, but three-dimensional model data is generated separately for the model and the attachment.

The frame 412 supporting the attachment 309 is configured as a frame body surrounding the attachment 309 and is used as an index for identifying a range in which the attachment 309 is arranged. That is, a three-dimensional object existing inside the frame 412 is recognized as the attachment 309. The thickness of the frame 412 is desirably as thin as possible within a range in which strength is maintained so as not to block the line of sight of the scanner apparatus 413 as much as possible. For example, the thickness can be about 3 mm.

The model 300 and the frame 412 are arranged apart from each other so as to secure a certain distance. Depending on the rotation angle of the turntable 406, the frame 412 may be positioned on the front side of the model 300 with respect to the scanner apparatus 413, and the imaging of the model 300 may be blocked. A portion blocked in this manner needs to be complemented at another rotation angle. However, if the model 300 and the frame 412 are too close to each other, complementation accuracy is decreased. Therefore, a certain distance is secured so as to secure the complementation accuracy.

At this time, in order to secure a certain distance between the model 300 and the frame 412 (or in order that the model and the frame are not too close to each other), for example, sizes of the model 300 and the attachment 309 may be limited to sizes equal to or smaller than predetermined sizes. For example, the model 300 may be 15 cm long, 15 cm wide, and 10 cm deep or less in size, and the attachment 309 may be 15 cm long, 5 cm wide, and 2 cm thick or less in size.

In the present embodiment, an installation base 414 on which the action base 411 supporting the model 300 is installed is thicker than an installation base 415 on which the frame 412 supporting the attachment 309 is installed. That is, the model 300 is installed so as to be located relatively above the attachment 309. As an example, the model 300 can be installed such that at least an upper body or upper half thereof is located above the frame 412. Therefore, when the model 300 is scanned, it is possible to decrease a ratio of blocking by the attachment 309 and increase a success rate of scanning.

Next, a more specific configuration of the operation apparatus 160 according to the present embodiment will be described with reference to FIG. 4C. FIG. 4C illustrates the operation apparatus 160 as a configuration including the output unit 160A, the operation unit 160B, and a seat 160C. When the user sits in the seat 160C, the output unit 160A is arranged so as to cover the front, and the user can experience the sense of immersion. The output unit 160A includes displays in at least three directions of front, left, and right, and displays video that is displayed in a virtual space by using the three-dimensional model data provided from the information processing apparatus 100 as the virtual space data. A speaker for performing audio output may be arranged in the output unit 160A. The user in the seat 160C can perform an operation input by operating the operation unit 160B configured as a lever, a pedal, or the like, the received operation result is transmitted to the information processing apparatus 100, and the displayed video and the output audio are updated according to the content of the operation. The seat 160C can vibrate according to the displayed video and the operation of the operation unit 160B. A speaker for audio output may also be arranged in the seat 160C and can perform audio output according to the video or audio output according to the vibration of the seat 160C. A blower can further be arranged in the output unit 160A or the seat 160C to output air according to video or audio. Further, an LED light emitting unit can be appropriately arranged in the output unit 160A to perform light emission output.

Next, an example of processing executed by the image processing system 10 according to the present embodiment will be described with reference to FIG. 5. At least a part of the processing corresponding to the flowchart is achieved by the CPU 101 of the information processing apparatus 100 executing a program stored in the ROM 103 or the storage apparatus 104.

First, in S501, the CPU 101 receives user registration. The CPU receives input of a user name and contact information. A user identifier for uniquely identifying each user is given to each user. The CPU 101 stores the input user information in the storage apparatus 104 in association with time when the input has been received and the user identifier.

When the user registration is completed, the user sets his/her own model in the model support apparatus 130. The CPU 101 can determine whether or not the model 300 and the attachment 309 have been set in the model support apparatus 130 on the basis of a scanned image by the scanner 110. Alternatively, a switch that is turned on when the model 300 and the attachment 309 are set may be arranged in the model support apparatus 130, and the CPU 101 may detect and determine a signal from the switch. Alternatively, a button for receiving an operation in a case where setting of the model 300 and the attachment 309 is completed is displayed on the display apparatus 140, and the CPU 101 can detect whether or not an operation for the button operation has been received. In S502, the CPU 101 detects that the model 300 and the attachment 309 have been set in the model support apparatus 130 by any of the methods described above. In response to the detection, the processing proceeds to S503.

Here, in a case where setting of the attachment 309 is not detected when a certain period of time elapses from setting of at least the model 300, the processing may proceed to S503. Alternatively, only in a case where the frame 412 is set, whether or not the attachment 309 is set may be detected.

In S503, the scanner 110, the support arm 120, and the model support apparatus 130 execute scanning processing (imaging processing) in cooperation to generate a scanned image. Specifically, the CPU 101 controls the support arm 120 to move the scanner 110 to any registered imaging position, and the scanner 110 can perform scanning while rotating the model support apparatus 130 at the imaging position. After the model support apparatus 130 is stopped at a predetermined rotation angle, it is possible to perform an imaging operation by the scanner 110 at an arbitrary imaging position and imaging angle. Specifically, in a state where front surfaces of the model 300 and the attachment 309 are located in front of the scanner apparatus 413, the front surfaces, left and right side surfaces, flat surfaces, and bottom surfaces of the model 300 and the attachment 309 are scanned by operating the support arm 402 up to a movable range limit. Thereafter, the turntable 406 is rotated to scan the model 300 and the attachment 309 at a predetermined rotation angle. At this time, scanning is performed so as to complement a portion blocked by the frame 412 and the attachment 309 (among surfaces of the model 300, a surface on a side on which the frame 412 and the attachment 309 are arranged) in the appearance of the model 300. In S503, for example, a scanning operation can be switched so as to change a scanning range according to the presence or absence or the type of attachment.

In subsequent S504, the CPU 101 executes post-scanning processing on the scanned image acquired by the scan processing and generates three-dimensional model data of the model 300 and the attachment 309. In generation of the three-dimensional model data, in a case where the three-dimensional model data of the attachment 309 is generated, the three-dimensional model data of the attachment 309 is associated with a predetermined position of the three-dimensional model data of the model 300. For example, in a case where the three-dimensional model data of the attachment 309 is not generated while the attachment is a hand-gripping type attachment, such association is not performed.

In the post-scanning processing, an area where an unnecessary data range is defined is created in advance, and a surface included in an area where data does not need to be read is deleted. This makes it possible to substantially remove surfaces other than the model 300 or the attachment 309. The unnecessary data range includes an area where the action base 411, the installation base 414, the frame 412, the support member 412A, the installation base 415, and the like are located.

In subsequent S505, the CPU 101 performs type determination processing of determining the type of a subject to be scanned on the basis of the three-dimensional model data generated in S504. In the type determination processing, for example, the CPU 101 compares a rendered image obtained by rendering using the three-dimensional model data with a reference image stored in the storage apparatus 104 and determines a type value regarding the type of the subject on the basis of a degree of matching with the reference image.

The reference image includes an image of a model classified in advance as the first type and a rendered image of the model, an image of a model classified in advance as the second type and a rendered image of the model, and an image of a model classified in advance as the third type and a rendered image of the model. The rendered image is generated by setting a viewpoint from an oblique upper surface as an angle of view at which models having different sizes can be covered to some extent and the entire atmosphere is easily understood. A background color can be 50% gray, for example.

The type value indicates a degree of the subject belonging to the type according to the magnitude of the value, and any value from 0 to 10 is assigned to the first type, the second type, and the third type. The value 0 indicates that the degree of belonging to the type is the lowest, and the value 10 indicates that the degree of belonging to the type is the highest.

In the type determination processing, in a case where characteristics of the reference images of the first type, the second type, and the third type are extracted in the rendered image to be determined, the processing is performed such that the values of the corresponding types become high. For example, the second type has a configuration characteristic for quick movement. Specifically, the second type has characteristics such as one having limbs and a body that look thinner than those of other types, one to which a wing-like part having a thin plate shape, a sharp shape, or the like is added, and one to which many injectors for obtaining propulsion are attached.

The third type has a configuration characteristic of putting greater emphasis on equipment so as to have excellent defense power than on quick movement as in the second type. Specifically, the third type has characteristics such as one having limbs and a body that look relatively thicker than those of other types, one to which configurations for defense, for example, parts such as a shield and an armor are added, and one equipped with a heavy weight weapon such as a large diameter gun.

The first type is between the second type and the third type and does not significantly have the characteristics of the second type or the characteristics of the third type.

The reference image can include not only an image of the model main body but also an image of the attachment, and in a case where a rendered image includes the image of the attachment, the type of the subject can be determined with further reference to the degree of matching with a characteristic of the attachment. For example, in a case where the rendered image includes an attachment that is similar to or matches an attachment included in the reference image of the third-type subject, a value of the third-type may be added. Further, reference images can be prepared as images captured from a plurality of viewpoints, and the type determination processing can also be performed by using the rendered images generated for the plurality of viewpoints. This is because the type of the subject can be determined with reference to not only characteristics of the front surface but also characteristics of the back surface.

When the type values of the first type to the third type of the subject to be determined are obtained in this manner, the CPU 101 determines the type of the subject to be determined on the basis of the obtained values. Specifically, the type can be determined on the basis of the value of the type having the largest value.

For example, in a case where the value of the third type is the largest, such as Td (type value of first type: T1, type value of second type: T2, type value of third type: T3)=(7, 6, 8), the type is determined as the third type. In a case where the value of the first type matches the value of the second type and/or the value of the third type, and the value is larger than the other values, the type can be determined as the first type. For example, in a case where the value of the first type is the largest and the first type matches another type, such as (T1, T2, T3)=(8, 8, 7), the type is determined as the first type. This is because the first type is assigned to the general-purpose type.

When the type determination is completed, individual parameter values (a plurality of first parameter values) for each type are then determined. In the present embodiment, five parameter types are assumed, but the number of parameter types may be less than or equal to or more than five. The five types include, for example, operability as a parameter 1, mobility as a parameter 2, attack speed as a parameter 3, defense power (armor) as a parameter 4, and attack power as a parameter 5. These parameters can be calculated on the basis of the type value used for the above-described type determination.

In the present embodiment, the following reference values can be set for the first type, the second type, and the third type. For the operability that is the parameter 1, (reference value of first type: R11, reference value of second type: R21, reference value of third type: R31)=(10, 3, 4) are set. Similarly, (R12, R22, R32)=(4, 10, 1) can be set for the mobility that is the parameter 2, (R13, R23, R33)=(4, 8, 2) can be set for the attack speed that is the parameter 3, (R14, R24, R34)=(4, 2, 8) can be set for the defense power that is the parameter 4, and (R14, R24, R34)=(4, 1, 10) can be set for the attack power that is the parameter 5.

Then, values (Pn: P1 to P5) from the parameter 1 to the parameter 5, which are the plurality of first parameter values, can be calculated by using the following calculation equation, for example.

$$Pn = ( R 1 n * T {1}^{2} / 100 ) + ( R 2 n * T {2}^{2} / 100 ) + ( R 3 n * T {3}^{2} / 100 ) \qquad ( Equation 1 )$$

$$( where n = 1 to 5 )$$

For example, in a case where the type is determined as the first type and the type values are (T1, T2, T3)=(7, 6, 5), the value of the parameter P1 that is the operability is P1=(10×49/100)+(3×36/100)+(4×25/100)=6.98. Similarly, the parameters P2 to P5 can be calculated. The results thus obtained are normalized such that the total value is 30.

For the above type determination processing, for example, generative AI can also be used. The type determination processing can be achieved by generating a prompt indicating conditions of the type determination described above, inputting the prompt to generative AI, and causing generative AI to execute the prompt.

In subsequent S506, the result of the type determination processing in S505 is output. For example, a display screen of the determination result can be displayed on the display apparatus 140. The display screen can display the type of the subject determined in S505 and display the plurality of first parameter values from the parameter 1 to the parameter 5 in the determined type by using a pentagonal graph (radar chart). At this time, the rendered image obtained by rendering using the three-dimensional model data generated in S504 may be included in the screen. For example, the display screen of the determination result can be displayed beside the rendered image. Therefore, the user can determine whether or not appropriate type classification has been performed while confirming the rendered image of the model captured by scanning.

FIG. 6 is a diagram illustrating an example of the display screen of the type determination result. The type determination result includes the first type to the third type as described above, and a display screen 600 illustrates an example of display in a case where the type is determined as the general-purpose type that is the first type. Here, the values of the parameters are displayed in a radar chart 601, and the determined type is displayed in a type display area 602. “General-purpose type (multi-type)” is displayed on the display screen 600. A display screen 610 illustrates an example of display in a case where the type is determined as the mobile type that is the second type, the values of the parameters are displayed in a radar chart 611, and “mobile type (speed type)” is displayed as the determined type in a type display area 612. A display screen 620 illustrates an example of display in a case where the type is determined as the heavily-equipped type that is the third type, the values of the parameters are displayed in a radar chart 621, and “heavily-equipped type (power type)” is displayed as the determined type in a type display area 622.

OK buttons 603, 613, and 623 operated by the user when accepting the determination result are displayed on each screen, and the user operates the OK button when accepting the determination result. When the user does not accept the determination result, for example, the displayed type may be changed by the user. Specifically, when the type display area 602 or the like is selected, the type may be changed. When the user selects the OK button 603 or the like with the changed content, the type is settled.

In subsequent S507, output processing is executed. In a case where the output processing is performed in the information processing apparatus 100, the CPU 101 generates application data for video display (display data) so as to include production (or information for designating production) according to the type of the subject on the basis of the three-dimensional model data of the model 300 and the attachment 309 generated in S504 and the type of the subject settled in S506. At this time, the application data can be generated so as to include production (or information for designating production) such as audio data, vibration data, air blowing data, and light emission data according to the type of the subject in accordance with the generated display data. The above pieces of data are collectively referred to as output data, and when the generated output data is executed by a specific application in the information processing apparatus 100, video, audio, and the like can be reproduced. Further, when the output data is executed by the specific application in the head mounted display 150A, VR video can be reproduced, and in addition, vibration output, audio output, and the like can be performed. The generated three-dimensional model data and output data are stored in the storage apparatus 104 in association with the user information and the like. Further, the CPU 101 executes the specific application corresponding to the output data and outputs the execution result to the display apparatus 140, the output unit 160A of the operation apparatus 160, and the like via the display control unit 107. The output data may be generated so as to include at least one of the above-described display data, audio data, vibration data, air blowing data, and light emission data.

In S507, the output processing including video display may be performed such that: the CPU 101 controls the communication apparatus 105 to transmit the output data to the HMD 150A; and the CPU 151 of the HMD 150A executes processing of displaying VR video by executing the received output data in a corresponding application. The output processing may also be performed such that: output data is transmitted to the operation apparatus 160; and the CPU 161 of the operation apparatus 160 executes processing such as video display and audio output by executing the received output data in a corresponding application.

As described above, in the video display, production for the model and the attachment can be switched according to the type determined in S506. For example, in a case where the type of the subject is the mobile type that is the second type, it is possible to perform production display that emphasizes the speed of motion of the model. In a case where the type of the subject is the heavily-equipped type that is the third type, production may be performed such that, when production display in which a bullet is fired from a firing weapon is performed, the size of the bullet is increased as compared with the other types. Meanwhile, the number of bullets fired per unit time can be increased for the second type, decreased for the third type, and set to the number therebetween for the first type. Display of the bullets at this time may be performed in different colors for each type.

Motion in an attack operation may be different depending on the type. For example, the second type can perform an operation in which faster motion is emphasized, the third type can perform an operation in which the sense of weight is emphasized, and the first type can perform an operation in which both the speed of motion and the sense of weight are achieved.

In the present embodiment, information regarding the production for each type can be tabulated as illustrated in FIG. 7A and held in the storage apparatus 104 of the information processing apparatus 100. In a table 700 of FIG. 7A, a plurality of common second parameter values can be registered for the first type, the second type, and the third type. The plurality of second parameter values includes moving speed, boost energy, continuous firing speed, hit score, damage point deduction, and damage durability, and different values can be set for each type (some values may be the same). In video display processing, the CPU 101 can read information of the table 700 from the storage apparatus 104 and determine parameters in production processing in consideration of the information of the table 700.

The table 700 of FIG. 7A can be referred to, for example, in a case where the CPU 101 executes the specific application corresponding to the above-described output data and generates video of a game performed by the user operating a three-dimensional model based on the output data. In the table 700, the parameter values of the first type are set to 5 as reference values, and the value is set to 7 in a case where performance is higher, whereas the value is set to 3 in a case where the performance is lower. However, this value assignment is merely an example and is not limited to this example.

The moving speed indicates the moving speed of the three-dimensional model, and the second type has a high moving speed (7), whereas the third type has a low moving speed (3). The boost energy indicates an amount of consumption of a “boost gauge” in which the moving speed is increased until the value becomes zero (when the value becomes zero, the boost cannot be performed) within a certain period of time, and the second type is high (the amount of consumption of the gauge is large: 7), whereas the third type is low (the amount of consumption of the gauge is small: 3). The continuous firing speed indicates the number of attacks within a certain period of time, and the second type is high (high speed continuous firing is possible: 7), whereas the third type is low (continuous firing is not good: 3). The hit score indicates a score obtained when an attack is hit, and the second type is low (the score is low as the continuous firing is possible: 3), whereas the third type is high (the score is high as the continuous firing is not good: 7). The damage point deduction indicates a degree of point deduction with respect to an amount of damage at the time of receiving damage (avoidance performance with respect to damage), and the second type is large (performance of avoiding attacks and reducing the amount of damage is high because the moving speed is high: 7), whereas the third type is small (performance of avoiding attacks and reducing the amount of damage is low because the moving speed is low: 3). The damage durability indicates a degree of durability at the time of receiving damage, and the second type has low durability (3), whereas the third type has high durability (7). Both the damage point deduction and the damage durability may be adopted, or only one of them may be adopted. For example, each basic point deduction amount is determined according to the type of attack, and a point deduction amount at the time of receiving damage can be determined by using the values of the damage point deduction and the damage durability (or any one of them).

The parameter values illustrated in FIG. 7A are merely examples, and additional parameters can also be registered. For example, a parameter regarding vibration can be added, and values of the vibration parameter can be set to be small in the order of the third type, the first type, and the second type. Therefore, vibration output in the production processing can be performed largely for the third type. Similarly, values of audio, air blowing, and light emission can be set according to the type.

In the flowchart of FIG. 5, when it is detected in S502 that the model has been set, the scanning processing is started, but input of information may be received from the user before the scanning processing is started. Specifically, it is possible to receive designation of the type and name of a model to be scanned, the type and name of an attachment, a desired type, and the like. For example, the model or the attachment is given a name in some cases, and information thereof can be used for the type determination. Further, in a case where the user desires production experience many times by using the same model, the production experience is not interesting if the type determination is always the same, and thus, in a case where the user desires a different type, designation of the type may be received in advance.

In a case where additional information input is received from the user in this manner, information as in a table 710 illustrated in FIG. 7B is held in the storage apparatus 104, and the CPU 101 can determine the type of the subject to be scanned in comparison with the information input in S504. The table 710 of FIG. 7B illustrates an example of a configuration of a data table that manages data of reference images. The table 710 of FIG. 7B includes a name of a model and a name of an attachment shown in a reference image in association with data of the reference image for each type. In a case where there is a plurality of types of attachments, registration may be performed for each attachment. At this time, each attachment may be registered in a different type. The reference image can include not only an image of the model main body, but also images of the plurality of attachments.

In a case where the name of the model and information of the attachment are provided from the user, the CPU 101 can search registered contents of the table 710, identify the corresponding model, acquire a reference image, and compare the reference image with the rendered image. By such processing, it is possible to reduce the load of the processing and to more efficiently identify the type of the model that is the subject to be scanned.

In a case where the user inputs the desired type, the CPU 101 can perform the processing so as to adopt the type designated by the user in principle. At this time, the CPU 101 can adjust the value of the determined type Td determined in the above-described type determination processing S505 such that the type value corresponding to the type desired by the user becomes maximum. Also in the determination of the parameter values P1 to P5 for each type, each parameter value may be calculated by using the value of the determined type Td after adjustment.

In a case where the desired type is input by the user, the CPU 101 may adopt the type designated by the user under a certain condition. For example, for the value of the determined type Td determined in the above-described type determination processing S505, it is possible to set a condition that a difference between a value of the designated type and a value of another type is not equal to or more than a threshold. Specifically, in a case where the difference between the value of the designated type and the value of another type is, for example, 3 or more, the user designation is not accepted because there is a bias, and in a case where the difference is, for example, 2 or less, the user designation is accepted. Further, in a case where the value of the designated type is the lowest value (third value) in the value of the determined type Td, the user designation may not be accepted, and in a case where the value is the second lowest value, the user designation may be accepted. In addition, the user designation can be accepted only under other predetermined conditions other than the above.

In the present embodiment, a notification unit for making a notification of a status of the processing in FIG. 5 can be provided. For example, an LED tape may be attached to at least one of the turntable 406, the action base 411, the installation base 414, the installation base 415, and the like, and the notification may be made by causing the LED tape to emit light in a different color according to the processing step during processing of FIG. 5. For example, the LED tape may be caused to emit light in a first emission color (for example, red) during the processing in S501 and S502. Thereafter, in a case where scanning is started, the LED tape may be caused to emit light in a second emission color (for example, white). After the scanning processing is completed, the LED tape may be caused to emit light in a third emission color (for example, blue) in the processing in and after S504. The light emission may be continued during the processing, or the light emission may be performed for a certain period of time (for example, 5 seconds or 10 seconds), and then the light emission may be turned off.

As described above, in the present embodiment, when three-dimensional model data generated from an image obtained by imaging a model with a scanner is arranged in a virtual space to generate display data for displaying video, the three-dimensional model data can be generated by simultaneously imaging the model together with an attachment thereof, and the type of a subject can be determined on the basis of a rendered image obtained from the generated three-dimensional model data. The determined type of the subject can be used to switch various types of production when video is output to the user. That is, in the present embodiment, production according to the type of the scanned subject can be provided for the user. Further, because the type of the subject not only is determined by the information processing apparatus 100 but also can be designated by the user himself/herself, it is possible to experience production expected by the user.

In the above-described embodiment, a case where the type of the subject is classified into the three types of the general-purpose type, the mobile type, and the heavily-equipped type has been described, but the embodiment of the disclosure is not limited thereto. The type can be changed according to the type of the subject to be scanned. For example, in a case where a target to be scanned is a model or a doll of an animal or a virtual living body, the type may be set from different viewpoints, such as a herbivorous type, a carnivorous type, and an omnivorous type, a charming type, a powerful type, and a calm type. In these cases, as well as in the above-described embodiment, a rendered image can be generated from three-dimensional model data obtained for the target to be scanned, and the corresponding type can be determined in comparison with a reference image for each classification. Further, production can be switched according to the determined type.

In the above-described embodiment, the description has been made on the assumption that the attachment is a weapon, but the type of the attachment is not limited to the weapon. For example, in a case where the model is a specific human-shaped character, the attachment may be a dress, an accessory, or the like worn by the character. It is also possible to make the model appear in an event, a concert, a sport, an online meeting, or the like performed in the virtual space. Further, it is also possible to apply the technique of the present embodiment to a video technique of fusing the real world and the virtual world and enabling perception of things that do not exist in the real space, such as cross reality (XR).

As described above, in the present embodiment, it is possible to generate three-dimensional model data from an image obtained by imaging an appearance of a model and an attachment thereof and to view video in which a three-dimensional model is arranged in a virtual space. Some models and attachments are finished as unique works by the user performing painting or the like, for example, like an assembled plastic model, and their individuality can be reflected in a moving image or character representation in the virtual space, and thus preference can be remarkably improved.

### Summary of Embodiment

The above embodiment discloses at least the following information processing apparatus and computer program.

(1) An information processing apparatus including:
a scanning control unit that controls a position and an angle of a scanner, scans an appearance of a subject installed on an installation base, and generates a scanned image;
a data generation unit that generates three-dimensional model data from the scanned image;
a determination unit that determines a type of the subject from among a plurality of types on the basis of a rendered image of the subject generated on the basis of the three-dimensional model data;
a data generation unit that generates output data including video in which a three-dimensional model based on the three-dimensional model data is arranged in a virtual space; and
an output unit that outputs the output data to an external output apparatus, in which
the data generation unit generates the output data so as to include production for each subject according to the type of the subject determined by the determination unit.

(2) The information processing apparatus according to (1), in which:
the determination unit determines the type of the subject on the basis of comparison between the rendered image and a plurality of reference images; and
each of the plurality of reference images is associated with any one of the plurality of types.

(3) The information processing apparatus according to (2), in which
the determination unit determines the type of the subject on the basis of a type associated with a reference image having a high degree of matching with the rendered image.

(4) The information processing apparatus according to (3), in which:
the subject includes a first subject and a second subject, and the second subject is an attachment of the first subject; and
in a case where the rendered image includes a first rendered image of the first subject and a second rendered image of the second subject, the determination unit determines the type of the subject on the basis of a type associated with a reference image having a high degree of matching with the first rendered image and a high degree of matching with the second rendered image.

(5) The information processing apparatus according to any one of (2) to (4), in which
in a case where input of information regarding the subject is received from a user, the determination unit determines the type of the subject by further referring to the input information.

(6) The information processing apparatus according to (5), in which:
each of the plurality of reference images is associated with information regarding a corresponding subject; and
in a case where input of the information regarding the subject is received, the determination unit determines the type of the subject further on the basis of a degree of matching between the input information regarding the subject and the information regarding the corresponding subject.

(7) The information processing apparatus according to (5) or (6), in which
the information regarding the subject includes information regarding names of the first subject and the second subject.

(8) The information processing apparatus according to any one of (1) to (7), in which:
the plurality of types includes at least three types; and
the determination unit determines a type value indicating a degree of belonging to the type for each of the three types and determines the type of the subject on the basis of the type value.

(9) The information processing apparatus according to (8), in which:
the at least three types include a first type, a second type, and a third type;
the second type is a type in which a first characteristic is emphasized and a second characteristic different from the first characteristic is suppressed in production in the video;
the third type is a type in which the second characteristic is emphasized and the first characteristic is suppressed in production in the video; and
the first type is between the second type and the third type in production of the first characteristic and the second characteristic in the video.

(10) The information processing apparatus according to claim (9), in which
the first characteristic is a sense of speed in the production, and the second characteristic is a sense of weight in the production.

(11) The information processing apparatus according to (9) or (10), in which
the determination unit determines the type of the subject on the basis of the type value having a largest value.

(12) The information processing apparatus according to (11), in which
in a case where there is a plurality of the type values having the largest value, the determination unit determines the type of the subject as the second type.

(13) The information processing apparatus according to (9), in which:
a determination result in the determination unit is displayed on a display unit; and
a display screen of the display unit includes display of the determined type of the subject.

(14) The information processing apparatus according to (13), in which:
the determination unit calculates a plurality of first parameter values common to the three types on the basis of the type value; and
the display screen further includes display of the plurality of first parameter values calculated for the type of the displayed subject.

(15) The information processing apparatus according to (14), in which
the display of the plurality of first parameter values is displayed by using a radar chart.

(16) The information processing apparatus according to any one of (1) to (15), further including
an operation unit that receives an operation from the user, in which
in a case where an operation of changing the type of the subject is received via the operation unit with respect to the display of the type of the subject displayed on the display unit, the data generation unit generates the output data so as to include production for each subject according to the type of the subject subjected to the change received via the operation unit.

(17) The information processing apparatus according to any one of (1) to (16), in which
the production includes at least one of video, audio, vibration, air blowing, or light emission.

(18) The information processing apparatus according to (17), in which:
a plurality of second parameter values common to the plurality of types and different for each of the types is used for the production; and
the data generation unit generates the output data so as to include production based on the plurality of second parameter values selected according to the type of the subject determined by the determination unit.

(19) The information processing apparatus according to any one of (1) to (18), in which
the output apparatus includes at least one of a head mounted display apparatus or an operation apparatus including an output unit and an operation unit.

(20) A computer program for causing a computer to function as the information processing apparatus according to any one of (1) to (19).

The disclosure is not limited to the above-described embodiment, and various modifications and changes can be made within the scope of the gist of the disclosure.

What is claimed is:

1. An information processing apparatus comprising:
a scanning control unit that controls a position and an angle of a scanner, scans an appearance of a subject installed on an installation base, and generates a scanned image;
a data generation unit that generates three-dimensional model data from the scanned image;
a determination unit that determines a type of the subject from among a plurality of types on the basis of a rendered image of the subject generated on the basis of the three-dimensional model data;
a data generation unit that generates output data including video in which a three-dimensional model based on the three-dimensional model data is arranged in a virtual space; and
an output unit that outputs the output data to an external output apparatus, wherein
the data generation unit generates the output data so as to include production for each subject according to the type of the subject determined by the determination unit.

2. The information processing apparatus according to claim 1, wherein:
the determination unit determines the type of the subject on the basis of comparison between the rendered image and a plurality of reference images; and
each of the plurality of reference images is associated with any one of the plurality of types.

3. The information processing apparatus according to claim 2, wherein
the determination unit determines the type of the subject on the basis of a type associated with a reference image having a high degree of matching with the rendered image.

4. The information processing apparatus according to claim 3, wherein:
the subject includes a first subject and a second subject, and the second subject is an attachment of the first subject; and
in a case where the rendered image includes a first rendered image of the first subject and a second rendered image of the second subject, the determination unit determines the type of the subject on the basis of a type associated with a reference image having a high degree of matching with the first rendered image and a high degree of matching with the second rendered image.

5. The information processing apparatus according to claim 4, wherein
in a case where input of information regarding the subject is received from a user, the determination unit determines the type of the subject by further referring to the input information.

6. The information processing apparatus according to claim 5, wherein:
each of the plurality of reference images is associated with information regarding a corresponding subject; and
in a case where input of the information regarding the subject is received, the determination unit determines the type of the subject further on the basis of a degree of matching between the input information regarding the subject and the information regarding the corresponding subject.

7. The information processing apparatus according to claim 6, wherein
the information regarding the subject includes information regarding names of the first subject and the second subject.

8. The information processing apparatus according to claim 6, wherein:
the plurality of types includes at least three types; and
the determination unit determines a type value indicating a degree of belonging to the type for each of the three types and determines the type of the subject on the basis of the type value.

9. The information processing apparatus according to claim 8, wherein:
the at least three types include a first type, a second type, and a third type;
the second type is a type in which a first characteristic is emphasized and a second characteristic different from the first characteristic is suppressed in production in the video;
the third type is a type in which the second characteristic is emphasized and the first characteristic is suppressed in production in the video; and
the first type is between the second type and the third type in production of the first characteristic and the second characteristic in the video.

10. The information processing apparatus according to claim 9, wherein
the first characteristic is a sense of speed in the production, and the second characteristic is a sense of weight in the production.

11. The information processing apparatus according to claim 9, wherein
the determination unit determines the type of the subject on the basis of the type value having a largest value.

12. The information processing apparatus according to claim 11, wherein
in a case where there is a plurality of the type values having the largest value, the determination unit determines the type of the subject as the second type.

13. The information processing apparatus according to claim 9, wherein:
a determination result in the determination unit is displayed on a display unit; and
a display screen of the display unit includes display of the determined type of the subject.

14. The information processing apparatus according to claim 13, wherein:
the determination unit calculates a plurality of first parameter values common to the three types on the basis of the type value; and
the display screen further includes display of the plurality of first parameter values calculated for the type of the displayed subject.

15. The information processing apparatus according to claim 14, wherein
the display of the plurality of first parameter values is displayed by using a radar chart.

16. The information processing apparatus according to claim 14, further comprising
an operation unit that receives an operation from the user, wherein
in a case where an operation of changing the type of the subject is received via the operation unit with respect to the display of the type of the subject displayed on the display unit, the data generation unit generates the output data so as to include production for each subject according to the type of the subject subjected to the change received via the operation unit.

17. The information processing apparatus according to claim 16, wherein
the production includes at least one of video, audio, vibration, air blowing, or light emission.

18. The information processing apparatus according to claim 17, wherein:
a plurality of second parameter values common to the plurality of types and different for each of the types is used for the production; and
the data generation unit generates the output data so as to include production based on the plurality of second parameter values selected according to the type of the subject determined by the determination unit.

19. The information processing apparatus according to claim 18, wherein
the output apparatus includes at least one of a head mounted display apparatus or an operation apparatus including an output unit and an operation unit.

20. A non-transitory computer-readable medium strong a program for causing a computer to function as the information processing apparatus according to claim 1.
